(19) United States
(12) Patent Application Publication
(10) Pub. No.: US 2026/0115929 A1
(43) Pub. Date: Apr. 30, 2026

(54) PROCESS FOR AUTOMATED HANDLING OF WORKPIECES AND AUTOMATION MODULE

(71) Applicant: MG Beteiligungsgesellschaft mbH, Geislingen/Steige (DE)

(72) Inventors: Magnus GRÜNER, Geislingen/Steige (DE); Tobias GRÜNER, Geislingen/Steige (DE)

(21) Appl. No.: 19/371,695

(22) Filed: Oct. 28, 2025

(30) Foreign Application Priority Data
Oct. 30, 2024 (EP) 24209752.5

(51) Int. Cl. B25J 9/16

(52) U.S. Cl. CPC B25J 9/1697

(57) ABSTRACT

A method for the automated handling of workpieces using an automation module with a base gantry, a removal area, a storage area, a robot device arranged on the base gantry and having a gripper that can be moved into a closed position and into an open position, a camera device arranged on the base gantry and directed toward the removal area, and a control device.

### CROSS-REFERENCE TO RELATED APPLICATION

This application claims priority to European application no. 24209752.5 filed October 30, 2024, which is incorporated by reference.

### BACKGROUND

The invention relates to a method for automated handling of workpieces and an automation module

### SUMMARY

The objective of the present invention is to provide a method for automated handling of workpieces and an automation module that are efficient and flexible.

The objective is achieved by the following method:

The method for automated handling of workpieces is carried out using an automation module with a base gantry, a removal area, a storage area, a robot device arranged on the base gantry and equipped with a gripper that can be moved into a closed position and an open position, a camera device arranged on the base gantry and directed toward the removal area, and a control device.

The method comprises the following steps:

In step a. a blank carrier with an open top and outer sides is provided in the removal area, wherein several workpieces, each having a gripping area, are accommodated in the blank carrier, wherein the workpieces are each arranged with their gripping area facing the top and otherwise randomly in relation to each other and in relation to the outer sides. In step b. a position image of the blank carrier and the workpieces arranged in the blank carrier is recorded by means of the camera device. In step c. position information of the workpieces in relation to each other and in relation to the outer sides is determined taking into account the position image, wherein the position information comprises individual positions of the workpieces in the blank carrier. In step d. a suitable workpiece to be gripped is selected from the workpieces arranged in the blank carrier, taking into account the position information. In step e. the robot device is controlled by the control device by transmitting the position of the selected workpiece so that the gripper is moved toward the workpiece, the workpiece is gripped by the gripper, and the gripped workpiece is removed from the blank carrier.

In step f., the gripped workpiece is placed at a storage position selected from a group of predetermined storage positions in the storage area, wherein workpieces placed at the storage positions are aligned with each other according to a predetermined arrangement.

The automation module can be used in a processing plant, in particular in a metalworking plant. By means of the automation module or the method according to the invention, it is possible to place workpieces that are arranged largely at random, such as those delivered to the processing plant, in an orderly manner in the storage area, i.e., to convert them from a largely random arrangement into an orderly arrangement.

This simplifies the precise feeding of the workpieces to subsequent processes, for example to a machining process such as a cutting process, an assembly process, or a logistics process, thereby reducing the process time or cycle time and increasing process reliability. In the subsequent processes, the workpieces no longer need to be laboriously aligned. Instead, the workpieces can be fed directly to the machines performing the subsequent processes with the required alignment. This increases component accessibility and the associated flexibility.

Preferably, the aforementioned steps are performed sequentially according to their numbering, i.e., first step a. then step b. and so on, with step f. being performed as the last step.

The base gantry of the automation module has several gantry elements, for example, gantry beams and/or gantry walls.

A gantry beam is a rod-like element, for example, a beam.

A gantry wall is a flat element. The portal elements are designed and attached to each other in such a way that the robot device of the automation module and the camera device of the automation module are each arranged in an operational manner on the base gantry. This means that the base gantry can withstand movement of the gripper, which is used in particular to grip a workpiece, without impairing the positioning of the gripper or the recording of the position image by means of the camera device. The base gantry is designed to move the gripper without deforming the base gantry or deflecting the portal elements relative to each other.

The removal area of the automation module is arranged in relation to the base gantry in such a way that the gripper can be moved to the removal area in order to remove a workpiece from the blank carrier provided in the removal area. The deposit area of the automation module is arranged in relation to the base gantry in such a way that the gripper can be moved to the deposit area in order to deposit a workpiece in the deposit area. Preferably, the base gantry covers the removal area and/or the deposit area. Alternatively, the removal area and/or the deposit area is arranged next to the base gantry.

The robot device has the gripper. Workpieces can be gripped using the gripper. To grip a workpiece, the gripper is moved to the gripping area of the workpiece to be gripped. The gripper is then moved from an open position to a closed position. In the closed position, the gripper is clamped against the gripping area in such a way that a form-fitting and/or force-fitting connection is formed between the gripper and the gripping area and thus the workpiece. In particular, the connection between the gripper and the workpiece in the closed position is so firm that the workpiece does not slip off or away from the gripper.

If the workpiece is not gripped correctly, i.e., if the workpiece slips off or away from the gripper even though it is in the closed position, it may be provided for, in the sense of a re-gripping, that the workpiece is temporarily set down, the gripper is moved to the open position, the gripper is repositioned in relation to the workpiece, and then the gripper is moved back to the closed position. In particular, it may be provided that a position image of the temporarily deposited workpiece is recorded and position information of the temporarily deposited workpiece is determined taking into account the position image recorded of the temporarily deposited workpiece, wherein this position information comprises the position of the temporarily deposited workpiece.

Preferably, the robot device has a collision sensor. The collision sensor is designed to detect a collision of the gripper and/or a workpiece gripped by the gripper with the environment, in particular with the blank carrier and/or other workpieces. The control device may be designed to stop the movement of the robot device in the sense of an emergency stop if a collision is detected.

Position information of the workpieces in relation to each other and in relation to the outer sides refers to information concerning a corresponding arrangement of the workpieces, namely an arrangement of the workpieces in relation to each other and in relation to the blank carrier or its outer sides. The position information comprises individual positions of the workpieces in the blank carrier.

The position of the selected and/or re-gripped workpiece comprises spatial coordinates of the workpiece in question, i.e., coordinates in relation to an x-axis, in relation to a y-axis perpendicular to the x-axis, and in relation to a z-axis perpendicular to the x-axis and perpendicular to the y-axis. The x-axis and the y-axis form a horizontal plane.

The camera device is spaced apart from the removal area along the z-axis. The position and thus the spatial coordinates are transmitted from the control device to the robot device. The robot device is controlled by the control device so that the gripper is moved toward the workpiece, taking into account the position or spatial coordinates of the workpiece.

The blank carrier provided in the removal area is used to transport the workpieces. The blank carrier is preferably suitable for transport by vehicles, in particular by trucks. Metallic workpieces, for example castings, in which functional surfaces are to be machined, are used in particular as workpieces.

The blank carrier can be designed specifically for the component. For this purpose, for example, the height and/or base area of the blank carrier can be adapted to the height of the workpieces to be placed in the blank carrier and/or the base area, in particular of several workpieces to be placed in the blank carrier. In addition, inserts, in particular component-specific inserts, can be provided to serve as a base for the workpieces. The inserts can be arranged under and/or on a layer of workpieces. The inserts can have recesses in which the workpieces are accommodated. The inserts can be made of plastic. A single blank carrier can be filled with multiple layers of workpieces. In particular, individual layers of workpieces are separated from each other by an insert. In particular, the blank carrier is reusable. For example, the blank carrier is designed as a so-called mesh box, in which the outer sides are each designed in a mesh-like manner, i.e., partially open. Alternatively, the outer sides are closed. In addition, at least one outer side may be designed as a grid and at least one other outer side may be closed. Preferably, the blank carrier can be folded up when it has been emptied in order to save space when transporting empty blank carriers.

In order to make the transport of the blank carriers more efficient, it is particularly envisaged that several blank carriers can be stacked on top of each other. For this purpose, the blank carriers may have support surfaces on the outer sides, in particular in an area adjacent to the upper side, which protrude vertically from the outer sides and on which another blank carrier can be placed. These support surfaces reduce the size of the opening on the top side, thereby also reducing the area through which the gripper can penetrate the blank carrier or through which workpieces can be removed from the blank carrier. This results in undercuts, particularly for workpieces adjacent to at least one outer side and held in the blank carrier, for which there is a risk of collision when the workpieces in question are removed from the blank carrier.

These undercuts or contact surfaces are recorded as part of the blank carrier with the position image and reflected in the determined position information. When selecting the suitable workpiece to be gripped, the position information is taken into account in such a way that workpieces that cannot be removed due to the undercuts or contact surfaces are not selected as suitable workpieces.

In step a. the workpieces are arranged in a largely random order. Largely random means that the workpieces are arranged with their gripping area facing upwards and otherwise randomly in relation to each other and in relation to the outer sides. An otherwise random arrangement can be an arrangement in which the workpieces are rotated relative to each other, i.e., the gripper must be moved to different rotational positions relative to the different workpieces in order to be positioned in relation to the respective gripping area so that the workpieces can be gripped securely. In addition, an otherwise random arrangement can be, for example, an arrangement in which the workpieces are spaced at different distances from the outer sides of the blank carrier and/or from each other.

The positional image of the blank carrier and the workpieces arranged in the blank carrier, which is recorded in step b. is recorded by means of the camera device, which is spaced apart from the removal area along the z-axis. In this case, a position image is recorded in a plane defined by the x-axis and the y-axis or in a plane that runs parallel to the plane defined by the x-axis and the y-axis. The position image recorded in this way is at least two-dimensional.

In step c. position information of the workpieces in relation to each other and in relation to the outer sides of the blank carrier is determined, taking into account the at least two-dimensional position image. The position information comprises individual positions of the workpieces in the blank carrier. Accordingly, the position information can be used to determine the arrangement of the workpieces in the blank carrier.

In step d. a suitable workpiece to be gripped is selected from the workpieces arranged in the blank carrier, taking into account the position information. A suitable workpiece to be gripped is selected that can be gripped by the gripper, that the gripper can be moved to within its gripping range, and that can be removed from the blank carrier when gripped.

In step e. the selected workpiece is then removed from the blank carrier. Movement specifications are preferably taken into account when removing the gripped workpiece from the blank carrier. A movement specification is defined as a specification that relates to at least a first movement section of the removal process or the removal movement of the workpiece and on the basis of which the workpiece is moved by means of the robot device. For example, it may be provided that the workpiece is first tilted into a free area of the blank carrier before the workpiece is lifted in the z-direction. In particular, the movement specifications depend on the position information of the workpiece in question, for example, depending on whether the workpiece is covered along the z-axis by an undercut or a support surface.

In step f. the gripped workpiece is placed in an orderly manner in the storage area. Preferably, the storage positions are predetermined. This enables workpieces to be stored without having to determine the corresponding storage position before storage. Furthermore, it is preferable to store information during storage about where a workpiece has already been stored. This prevents different workpieces from being placed in the same storage position.

Further features advancing the invention are the subject of the dependent claims with the following features:

Preferably, the steps following the provision of the blank carrier are repeated for several different workpieces until there are no more workpieces in the blank carrier. If only a single workpiece remains in the blank carrier, a position image of the blank carrier and the single workpiece arranged in the blank carrier is recorded accordingly, position information of the workpiece is determined only in relation to the outer sides of the blank carrier, whereby the position information comprises only a position of the workpiece, and the remaining workpiece is selected as the workpiece to be gripped. The term “different workpieces” refers to the fact that the steps mentioned are not repeated for the same workpiece. The workpieces may be of the same type or of different types. However, it is preferable for the workpieces to be of the same type.

When determining the position information of the workpieces, in addition to the position image, the design data of the workpieces are also preferably taken into account. The design data are understood to be, in particular, three-dimensional outer contours or three-dimensional outer surfaces of the workpieces. This allows information regarding the z-axis and thus a third dimension to be obtained from the at least two-dimensional position image, which contains information regarding the x-axis and y-axis. Such information is referred to as depth information. The position information of the workpieces determined on the basis of the position image can thus be extended to include the depth information. This simplifies the approach to the workpieces, particularly with regard to the z-axis. Preferably, when recording the position image of the blank carrier and the workpieces arranged in the blank carrier, depth information is also captured by means of the camera device, whereby the depth information is preferably determined with the aid of a point cloud. Accordingly, the camera device is preferably designed to capture depth information in addition to the information relating to the x-axis and the y-axis, i.e., information relating to the z-axis. A corresponding camera device is referred to as a 2.5D camera device or a 3D camera device. Preferably, a point cloud is captured with the camera device. In this process, individual pixels of the captured image are assigned coordinates in relation to the x-axis, the y-axis, and the z-axis. The individual pixels together form the point cloud.

Furthermore, the depth information obtained by means of the first camera device and the depth information obtained on the basis of the design data are preferably compared with each other and/or supplemented with each other.

Preferably, the gripped workpiece is moved by the robot device to a code detection device arranged on the base gantry, and a first identification code applied to the gripped workpiece is detected by the code detection device. The first identification code is already present on the workpiece before it is made available in the removal area. In particular, the first identification code can be applied after the metal workpieces have been cast. If defects are detected in the workpiece in question during processes following its placement in the storage area, in particular testing processes, the first identification code can be used to trace where the workpiece came from or which processes the workpiece has previously undergone. Defects in the workpiece in question can be, for example, cracks in the workpiece, intolerable burrs on the workpiece, or an insufficient surface quality in certain areas of the workpiece.

Preferably, a second identification code is applied to the gripped workpiece by means of a processing device assigned to the automation module, taking into account the process information provided to the processing device. The second identification code serves in particular to track the workpiece in question within the processing plant. The process information comprises, in particular, a digital equivalent of the second identification code applied to the gripped workpiece and, preferably, a digital equivalent of the first identification code of the gripped workpiece. This allows the first identification code to be combined with the second identification code and stored. Furthermore, the second identification code is preferably applied to the gripped workpiece by means of a laser, in particular by means of a laser print head. The workpiece can be set down temporarily while the second identification code is being applied to it. This allows the gripper to grip and move another workpiece in the meantime.

Preferably, the process information is stored in a workpiece database. Furthermore, preferably, further process information relating to subsequent processes is stored in the workpiece database. This allows the workpiece database to be used to clearly trace the conditions under which a specific workpiece was processed using different machining processes.

When selecting a suitable workpiece to be gripped from the workpieces arranged in the blank carrier, it is preferable to check at least for individual workpieces held in the blank carrier whether there is a risk of process disruption in that the workpiece in question would collide with another workpiece and/ or with an outer side of the blank carrier until the check for a workpiece held in the blank carrier shows that there is no risk of a process disruption for the checked workpiece, whereupon this workpiece is selected as the workpiece to be gripped. This minimizes the risk of a process disruption occurring.

A process disruption can be the movement of a non-gripped workpiece, a collision of the gripped workpiece with a non-gripped workpiece, the movement of the blank carrier, and/or a collision of the gripped workpiece with the blank carrier. For the gripped workpiece, the corresponding test has at least shown that there is no risk of a process disruption that can be detected by the test and that is influenced by foreseeable influences or events. This does not rule out the possibility of a process disruption actually occurring, as other unforeseen influences or events that are not covered by the corresponding test may also lead to a process disruption. Such an unforeseen event could be, for example, a person entering the automation module or the automation module being damaged from the outside. At the same time, at least with regard to foreseeable influences, a risk of process disruption can be ruled out, thereby minimizing the actual risk of process disruption influenced by foreseeable and unforeseeable influences or events.

Preferably, gripping specifications are also taken into account when selecting a suitable workpiece to be gripped from the workpieces arranged in the blank carrier. In particular, the gripping specifications are taken into account in addition to the movement specifications. The gripping specifications can be workpiece-specific, i.e., a gripping specification applies to a specific workpiece. The workpiece-specific gripping specifications applicable to different workpieces may be the same for certain workpieces. In addition, the gripping specifications may be unique. Gripping specifications may, for example, stipulate that a particular workpiece may not be gripped until another workpiece has been removed from the blank carrier, or that a particular workpiece may only be gripped when a specific area of the blank carrier is free.

Preferably, at least one workpiece pallet is arranged in the storage area, onto which the gripped workpiece is placed, whereby, in particular after the workpiece pallet has been completely loaded with workpieces, the workpiece pallet is removed from the storage area by means of a transport system, in particular a driverless transport system. The workpiece pallet serves in particular as a means of transport for the workpieces, which are aligned with each other in accordance with the predetermined arrangement, to machines at which further processes are carried out with the workpieces. The transport system is mobile. The workpiece pallet is arranged on the transport system, in particular the workpiece pallet is arranged on the transport system. This can be done by moving the transport system under the workpiece pallet and then lifting it at least partially in order to lift the workpiece pallet. A driverless transport system is a self-propelled transport system, which means that no operator intervention is required for its operation. Alternatively, the workpiece pallet is removed manually from the storage area.

Preferably, the position of the workpiece pallet in the storage area is indexed. This means that the position of the workpiece pallet in the storage area is predetermined and no longer needs to be determined after the workpiece pallet has been placed in the storage area.

Preferably, when the blank carriers are provided by means of a transport system, in particular a driverless transport system, and/or by means of a feeding system, they are positioned in the removal area. A feeding system is a system with which the blank carrier can be moved from a predetermined position or a predetermined area, for example from a truck with which the blank carrier was transported, to another predetermined position or another predetermined area. Conveyor belts and/or systems with movable grippers are particularly suitable as feeding systems.

The task is also solved by an automation module with a base gantry, a removal area, a storage area, a robot device arranged on the base gantry with a gripper that can be moved into a closed position and an open position, a camera device arranged on the base gantry and directed towards the removal area, and a control device, wherein the automation module is designed to carry out the method described above.

Preferably, the base gantry has an at least partially open inlet side through which the blank carrier can be inserted into the automation module. Furthermore, the base gantry preferably has an at least partially open outlet side through which the workpiece pallet can be removed from the automation module. The inlet side and/or the outlet side can each be closed by a gate device.

The control device is preferably designed as a programmable logic controller.

The base gantry preferably has an outer first side part, an outer second side part spaced apart from the first side part, and a roof part resting on the first side part and on the second side part, wherein the camera device and/or the robot device are arranged on the roof part in such a way that they hang into a working space bounded by the first side part, the second side part, and the roof part.

The first side section, the second side section, and the roof section may each consist of several portal beams and/or portal walls. In particular, the first side section, the second side section, and/or the roof section are each clad with at least one portal wall. Preferably, the first side section, the second side section, and the roof section form a housing that serves as the outer structure of the automation module.

Preferably, the automation module has a code detection device. The code detection device can be attached to the first side part, the second side part, and/or the roof part.

Preferably, the base gantry has a third side part arranged between the first side part and the second side part, which divides the working space into a first working space area and a second working space area, wherein at least one component from the group: removal area, storage area, robot device, camera device is assigned only to the first working space area, wherein the automation module further comprises at least one further component from the group: removal area, storage area, robot device, camera device assigned only to the second working space area. In particular, a removal area and a storage area are provided in each of the first and second work areas. Alternatively, two or more removal areas and/or storage areas may be provided in the work area without the work area being divided into a first work area and a second work area. This allows workpieces to be removed in parallel from at least two blank carriers, one of which is assigned to the first working area and the other to the second working area. Furthermore, the code detection device may preferably be assigned only to the first work area, whereby the automation module also has a further code detection device that is assigned only to the second work area.

Preferably, the gripper has an expansion head which, in the open position, has a smaller outer circumference than in the closed position, whereby the gripper is designed to grip a workpiece by the expansion head pressing against an inner contour of the workpiece in the closed position. This allows workpieces to be gripped that are arranged in the blank carrier with a small distance between them. This would not be possible, or would only be possible with difficulty, if a gripper were used that has a gripping head with which the workpiece in question is gripped from the outside. The gripper with expansion head can be removed from the workpiece by the gripping head no longer pressing against the inner contour in the open position. The prerequisite for a workpiece to be grippable by means of a gripper with an expansion head is that the workpiece has a corresponding inner contour.

Alternatively or in addition, the gripper can have a parallel gripping head in which two gripping surfaces aligned parallel to each other are moved relative to each other in order to grip the workpiece. In particular, the parallel gripping head is designed to move the gripping surfaces toward each other in order to move from the open position to the closed position and to move away from each other in order to move from the closed position to the open position.

Furthermore, alternatively or in addition, the gripper may have a finger gripping head with at least two gripping fingers, each with at least two finger segments. The gripping fingers nestle against the workpiece to be gripped in order to move the finger gripping head from the open position to the closed position. In order to move the finger gripping head from the closed position to the open position, the gripping fingers are moved away from the workpiece.

Furthermore, alternatively or in addition, the gripper may have a vacuum gripping head with at least one suction element. To move the vacuum gripping head from the open position to the closed position, the suction element is moved toward the workpiece to be gripped and subjected to negative pressure in order to suck in the workpiece to be gripped. To move the vacuum gripper head from the closed position to the open position, the vacuum supply to the suction element is terminated.

### BRIEF DESCRIPTION OF THE DRAWINGS

The invention is explained in more detail below with reference to the accompanying drawing, which shows

FIG. 1 an automation module in an isometric view,

FIG. 2 the automation module shown in FIG. 1 without portal walls in an isometric view,

FIG. 3 shows another automation module with a first working area and a second working area in an abstract representation,

FIG. 4 shows a code cell in an abstract representation,

FIG. 5 shows a raw material loading carrier in which several workpieces are held, and

FIG. 6 shows a method.

### DETAILED DESCRIPTION

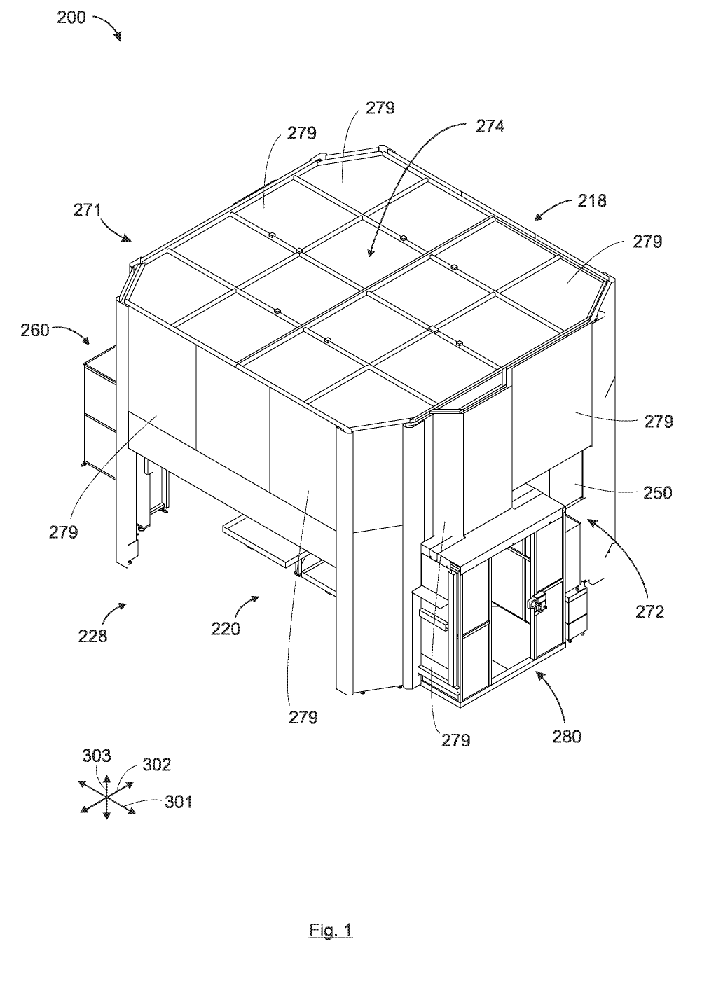

FIG. 1 shows an automation module 200. The automation module 200 extends along an x-axis 301, a y-axis 302 perpendicular to the x-axis 301, and a z-axis 303 perpendicular to the x-axis 301 and perpendicular to the y-axis 302.

The automation module 200 has a base gantry that is not marked with a reference symbol. The base gantry has several portal elements. Purely by way of example, the base gantry has portal elements designed as portal walls 279, which are arranged on portal elements designed as portal beams 278.

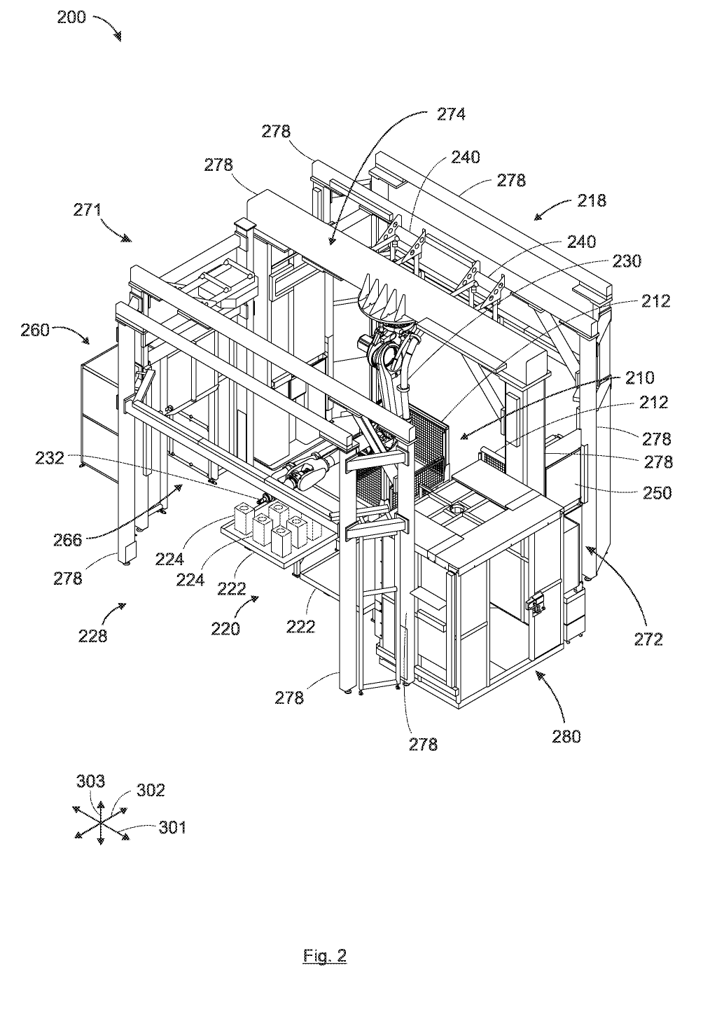

FIG. 2 shows the automation module shown in FIG. 1 without portal walls 279. FIG. 2 shows the portal beams 278 on which the portal walls are arranged or fastened. The automation module 200 also has a removal area 210 and a storage area 220. In addition, the automation module 200 has a robot device 230. The robot device 230 has a gripper 232 that can be moved into a closed position and an open position. Furthermore, the automation module 200 has a camera device 240 arranged on the base gantry and directed toward the removal area 210, and a control device 250.

Purely by way of example, the base gantry has an outer first side part 271, an outer second side part 272 spaced apart from the first side part 271, and a roof part 274 resting on the first side part 271 and on the second side part 272.

The camera device 240 and the robot device 230 are arranged on the roof part 274 in such a way that they hang into a working space bounded by the first side part 271, the second side part 272, and the roof part 274, which is not provided with a reference symbol.

The first side part 271, the second side part 272, and the roof part 274 each have several portal beams 278 and several portal walls 279. In FIGS. 1 and 2, for reasons of clarity, not all visible portal beams 278 and side walls 279 are provided with a reference symbol. The automation module 200 has an inlet side 218 and an outlet side 228. The inlet side 218 and the outlet side 228 are arranged on opposite sides of the automation module 200 with respect to the y-axis 302. The removal area 210 is accessible via the inlet side 218.

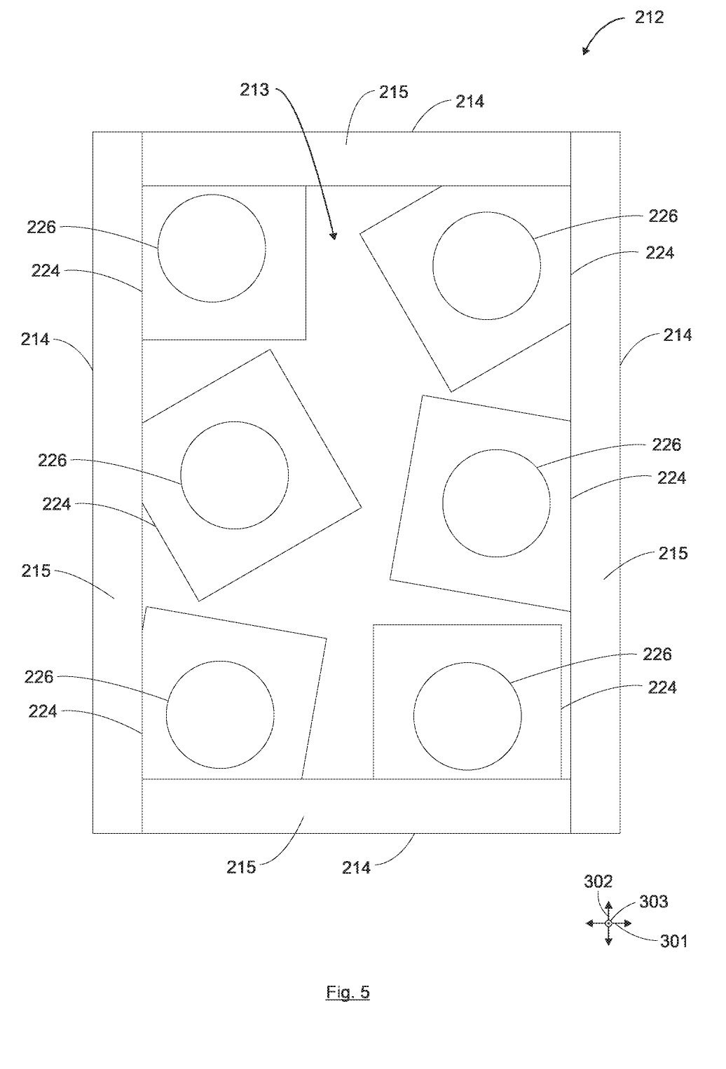

In addition, a blank carrier 212 can be inserted into the automation module 200 via the inlet side 218. By way of example, two blank carriers 212 are inserted into the automation module 200 and arranged in the removal area 210. Workpieces 224 can be accommodated in each of the blank carriers 212 (see FIG. 5). The workpieces 224 are provided in the blank carrier 212 or in the blank carriers 212.

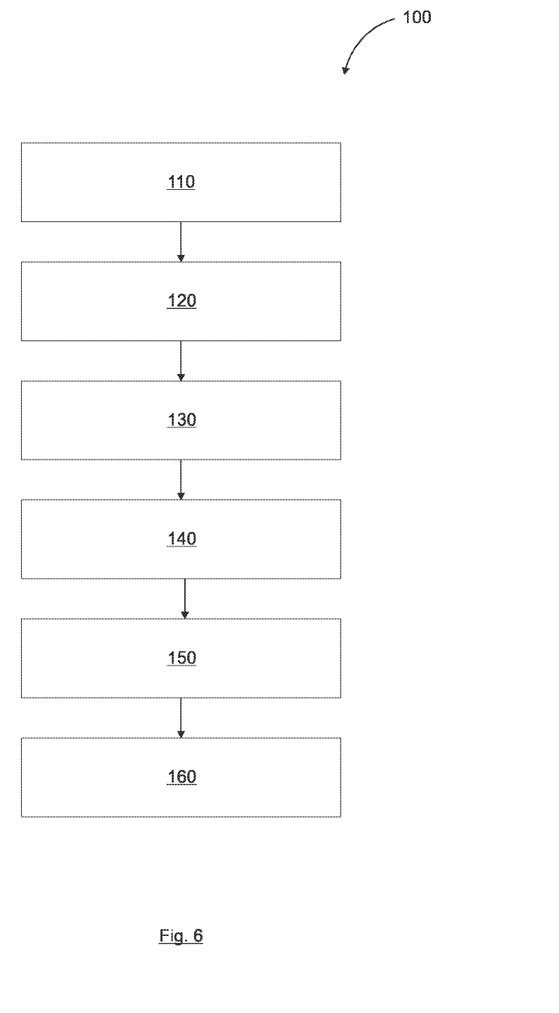

Using the robot device 230, the workpieces 224 can be removed from the blank carrier 212 or from the blank carriers 212 in the course of the process 100 shown in FIG. 6 and placed on the workpiece pallet 222 or on the workpiece pallets 222.

The storage area 220 is accessible via the outlet side 228.

In addition, a workpiece pallet 222 can be removed from the automation module 200 via the outlet side 228. Purely by way of example, two workpiece pallets 222 are inserted into the automation module 200 and arranged in the storage area 220. Workpieces 224 can be placed in each of the workpiece pallets 222. In FIG. 2, several workpieces 224 are placed on the workpiece pallet 222 arranged on the left in the illustration.

Purely by way of example, the automation module 200 is completely clad with portal walls 279, apart from the inlet side 218 and the outlet side 228. The inlet side 218 and the outlet side 228 are each only partially clad with portal walls 279 and are therefore each partially open.

Purely by way of example, the automation module 200 also has a code cell 260 and a feed device 280. By means of the feed device 280, further workpieces 224 can be fed to the automation module 200 independently of a blank carrier 212.

FIG. 3 shows another automation module 200. The automation module 200 shown in FIG. 3 differs from the automation module 200 shown in FIGS. 1 and 2 in that it has a third side panel 273. The third side panel 273 is arranged between the first side panel 271 and the second side panel 272 with respect to the x-axis 301. The third side panel 273 divides the working space into a first working space area 276 and a second working space area 277.

Purely by way of example, the automation module 200 has a removal area 210, a storage area 220, a robot device 230, and a camera device 240, each of which is assigned only to the first working space area 276.

Furthermore, by way of example, the automation module 200 has a further removal area 210, a further storage area 220, a further robot device 230 and a further camera device 240, each of which is assigned only to the second working area 277.

The description provided in connection with FIGS. 1 and 2 for the removal area 210, the storage area 220, the robot device 230, and the camera device 240 applies equally to the removal areas 210, storage areas 220, robot devices 230, and camera devices 240 shown in FIG. 3.

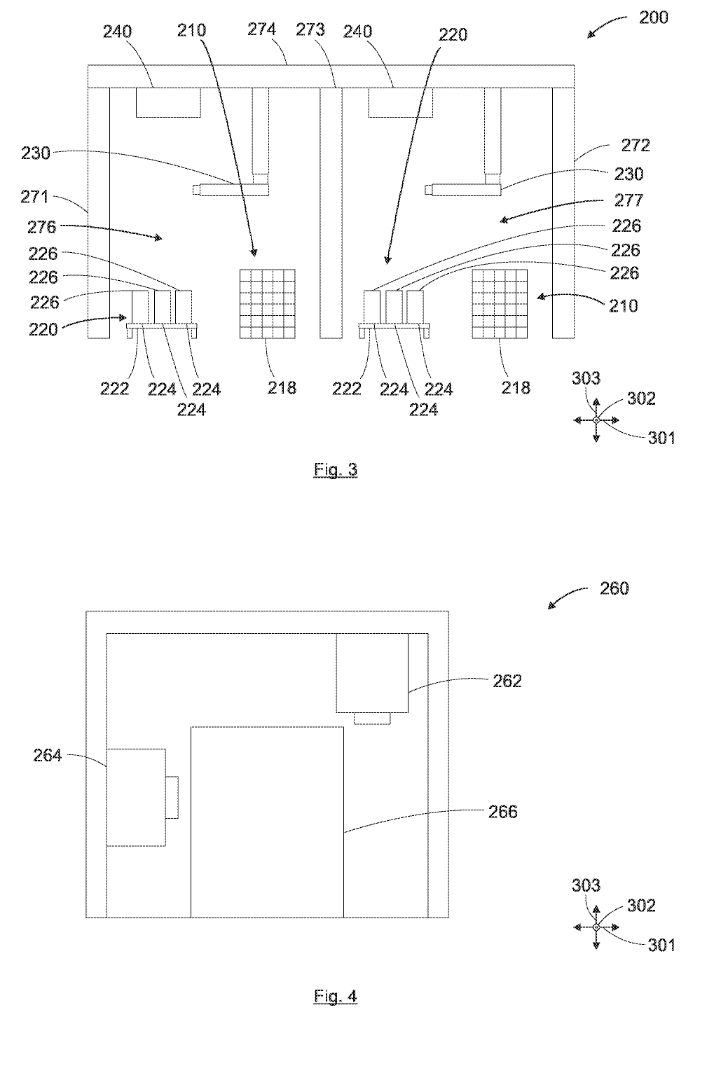

FIG. 4 shows the code cell 260 of the automation module 200 shown in FIGS. 1 and 2. By way of example, the code cell 260 has an access opening 266 (see FIG. 2), through which the code cell 260 is accessible from the working space. In particular, the gripper 232 can enter the code cell 260 through the access opening 266.

Furthermore, the code cell 260 has, for example, a code detection device 262 and a processing device 264.

FIG. 5 shows a blank carrier 212 in which several workpieces 224 are accommodated. The blank carrier 212 has an open top side 213 and, purely by way of example, four outer sides 214.

Furthermore, by way of example, the top side 213 extends in a plane defined by the x-axis 301 and the y-axis 302 or in a plane that runs parallel to the plane defined by the x-axis 301 and the y-axis 302. The outer sides 214 shown on the left and right sides in FIG. 5 on the left and right sides extend in a plane defined by the y-axis 302 and the z-axis 303 or in a plane that runs parallel to the plane defined by the y-axis 302 and the z-axis 303. The outer sides 214 shown in FIG. 5 above and below extend in a plane defined by the x-axis 301 and the z-axis 303, respectively, in a plane parallel to the plane defined by the x-axis 301 and the z-axis 303.

The workpieces 224 each have a gripping area 226. The workpieces 224 are each arranged in the blank carrier 212 in such a way that the gripping areas 226 face in the direction of the upper side 213. Otherwise, the workpieces 224 are arranged randomly in relation to each other and in relation to the outer sides 214.

Purely by way of example, the blank carrier 212 has support surfaces 215 on the outer sides 214 that protrude perpendicularly from the outer sides 214. The support surfaces 215 reduce the opening of the top side 213.

Furthermore, the gripping areas 226 of the individual workpieces 224 are each arranged internally in relation to the respective workpiece 224. In order to grip such workpieces 224, the gripper 232 can have an expansion head which, in the open position, has a smaller outer circumference than in the closed position. Such a gripper 232 is designed to grip a workpiece 224 by pressing the expansion head in the closed position against an inner contour of the workpiece 224, which is determined in particular by the gripping area 226.

FIG. 6 shows a method 100. The method 100 comprises six steps a. to f. 110, 120, 130, 140, 150, 160, which follow one another in a purely exemplary manner. The method 100 is carried out using the automation module 200 described above.

In step a. 110, a blank carrier 212 equipped with an open top 213 and outer sides 214 is provided in the removal area 210, wherein several workpieces 224, each having a gripping area 226, are loaded into the blank carrier 212, wherein the workpieces 224 each having a gripping area 226, the workpieces 224 each being arranged with their gripping area 226 in the direction of the top side 213 and otherwise randomly in relation to each other and in relation to the outer sides 214

In step b. 120, a positional image of the blank carrier 212 and the workpieces 224 arranged in the blank carrier 212 is recorded by means of the camera device 240.

In step c. 130, position information of the workpieces 224 in relation to each other and in relation to the outer sides 214 is determined taking into account the position image, wherein the position information comprises individual positions of the workpieces 224 in the blank carrier 212.

In step d. 140, a suitable workpiece 224 to be gripped is selected from the workpieces 224 arranged in the blank carrier 212, taking into account the position information.

In step e. 150 the robot device 230 is controlled by the control device 250 by transmitting the position of the selected workpiece 224, so that the gripper 232 is moved toward the workpiece 224, the workpiece 224 is gripped by means of the gripper 232, and the gripped workpiece 224 is removed from the blank carrier 212.

In step f. 160, the gripped workpiece 224 is deposited at a deposit position selected from a group of predetermined deposit positions in the deposit area 220, wherein workpieces 224 deposited at the deposit positions are aligned with each other according to a predetermined arrangement.

1. A method for the automated handling of workpieces using an automation module with a base gantry, a removal area, a storage area, a robot device arranged on the base gantry and having a gripper that can be moved into a closed position and an open position, a camera device arranged on the base gantry and directed toward the removal area, and a control device, wherein the method comprises the following steps:
a. providing a blank carrier equipped with an open top and outer sides in the removal area, wherein the blank carrier holds a plurality of workpieces, each of which has a gripping area, wherein the workpieces are each arranged with their gripping area facing the top side and are otherwise arranged randomly in relation to each other and in relation to the outer sides,
b. capturing an image of the position of the blank carrier and the workpieces arranged in the blank carrier using the camera device,
c. determining position information of the workpieces in relation to each other and in relation to the outer sides, taking into account the position image, wherein the position information comprises individual positions of the workpieces in the blank carrier,
d. selecting a suitable workpiece to be gripped from the workpieces arranged in the blank carrier, taking into account the position information,
e. controlling the robot device by means of the control device by transmitting the position of the selected workpiece, so that the gripper is moved toward the workpiece, the workpiece is gripped by means of the gripper, and the gripped workpiece is removed from the blank carrier,
f. placing the gripped workpiece at a placement position selected from a group of predetermined placement positions in the placement area, wherein workpieces placed at the placement positions are aligned with each other according to a predetermined arrangement.

2. The method according to claim 1, wherein the steps following the provision of the blank carrier are performed repeatedly for several different workpieces until no more workpieces are contained in the blank carrier.

3. The method according to claim 1, wherein when determining the position information of the workpieces, in addition to the position image, design data of the workpieces are also taken into account.

4. The method according to claim 1, wherein when recording the position image of the blank carrier and the workpieces arranged in the blank carrier by means of the camera device, depth information is also recorded, wherein the depth information is preferably determined with the aid of a point cloud.

5. The method according to claim 1, wherein the gripped workpiece is moved by means of the robot device to a code detection device arranged on the base gantry, and a first identification code applied to the gripped workpiece is detected by means of the code detection device.

6. The method according to claim 1, wherein a second identification code is applied to the gripped workpiece by means of a processing device assigned to the automation module, taking into account process information provided to the processing device.

7. The method according to claim 6, wherein the process information is stored in a workpiece database.

8. The method according to claim 1, wherein when selecting a suitable workpiece to be gripped from the workpieces arranged in the blank carrier, at least for individual workpieces picked up in the blank carrier are checked at least until the check for a workpiece picked up in the blank loading carrier shows that the workpiece being checked would collide with another workpiece and/or with an outer side of the blank loading carrier until the check for a workpiece held in the blank carrier shows that there is no risk of a process malfunction for the checked workpiece, whereupon this workpiece is selected as the workpiece to be gripped.

9. The method according to claim 1, wherein when selecting a suitable workpiece to be gripped from the workpieces arranged in the blank carrier, gripping specifications are also taken into account.

10. The method according to claim 1, wherein at least one workpiece pallet is arranged in the storage area, onto which the gripped workpiece is placed, wherein, in particular after the workpiece pallet has been completely loaded with workpieces, the workpiece pallet is removed from the storage area by means of a transport system, in particular an unmanned transport system.

11. The method according to claim 1, wherein when the blank carriers are supplied by means of a transport system, in particular a driverless transport system, and/or by means of a feeding system, they are positioned in the removal area.

12. An automation module with a base gantry, a removal area, a storage area, a robot device arranged on the base gantry and having a gripper that can be moved into a closed position and into an open position, a camera device arranged on the base gantry and directed toward the removal area, and a control device, wherein the automation module is designed to execute a method according to claim 1.

13. The automation module according to claim 12, wherein the base gantry has an outer first side part, an outer second side part spaced apart from the first side part, and a roof part resting on the first side part and on the second side part, wherein the camera device and/or the robot device are arranged on the roof part in such a way that they hang into a working space bounded by the first side part, the second side part, and the roof part.

14. The automation module according to claim 13, wherein a third side part arranged between the first side part and the second side part, which divides the working space into a first working space area and a second working space area, wherein at least one component from the group: removal area, storage area, robot device, camera device is assigned only to the first working space area, wherein the automation module further has at least one further component from the group: removal area, storage area, robot device, camera device.
